(19) United States
(12) Patent Application Publication
(10) Pub. No.: US 2014/0082938 A1
(43) Pub. Date: Mar. 27, 2014

(54) Waterproof wire connectors

(71) Applicants: Herbert King, JR., Jupiter, FL (US); William Hiner, O'Fallon, MO (US); James Keeven, O'Fallon, MO (US)

(72) Inventors: Herbert King, JR., Jupiter, FL (US); William Hiner, O'Fallon, MO (US); James Keeven, O'Fallon, MO (US)

(21) Appl. No.: 13/573,592

(22) Filed: Sep. 27, 2012

(51) Int. Cl. H01R 13/52; H01R 43/00

(52) U.S. Cl. CPC H01R 13/52; H01R 43/005
USPC 29/863; 439/271

(57) ABSTRACT

A waterproof wire connector comprising a push in wire connector having a wire chamber therein for receiving and forming electrical engagement with an electrical wire axially inserted therein with the wire connector having a wire port with a self healing member extending across the entry to the wire port to prevent moisture from entering the wire connector whereby pushing the wire into the wire connector forces the end of an electrical wire to pierce the self healing member.

### CROSS REFERENCE TO RELATED APPLICATIONS

This application claims priority from provisional application Ser. No. 61/628,205 filed Oct. 26, 2011.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

Numerous types of electrical wire connectors for forming bared ends of electrical wires into a waterproof electrical connection are known in the art. One type of electrical connector relies on inserting the wires into a sealant located between a terminal block and a terminal screw and then squeezing the bared ends of the wire by rotating the terminal screw. The more the terminal screw is tightening the greater the squeezing and hence the better the electrical connection between the bared wire end and the terminal screw.

Another type of electrical wire connector is a twist-on wire connector that can be used to form a waterproof electrical connection through rotation of the electrical wires in a spiral shape housing containing a sealant. In the twist-on wire connector as well as the terminal connector the more aggressive the rotation the greater the compression of the wire ends and hence an enhanced electrical connection between the electrical wires.

Another type of electrical connector is a push-in wire connector. A push-in wire connector is a less aggressive wire connector since the force on the wire by the connector is generated by a fixed cantilevered mounted electrical conductor that flexes to allow insertion of an electrical wire between the conductor and a bus strip. The clamping force holding the wire in electrical contact with bus strip and the electrical conductor of the push-in wire connector are determined by the resilient force of the electrical conductor and can not be increased by more aggressive action such as in twist-on wire connectors since the axial force applied to flex the resilient conductor in a push-in wire connector is limited by the stiffness of the wire. That is, to generate a clamping force on the electrical wire in a push-in wire connector the wire must be inserted in an axial direction, which is at 90 degrees to the direction of force generated by the resilient conductor. Thus the resilient electrical conductor in a push-in wire connector must flex in response to one axially inserting a wire therein. The wire clamping force in the push-in wire connector is limited because the axial resistance of the resilient conductor must not be so large so as to bend the electrical wire during the insertion process. Consequently, clamping forces generated by push-in wire connectors lack the inherent aggressive nature of other connectors that can force sealant away from contact areas between conductors in order to form a low resistance electrical contact.

Although the push-in wire connectors lack the aggressiveness of other electrical wire connectors the push-in wire connector are simple to use since an electrical connection can be made in one continuous motion. That is, one axially inserts an electrical wire into a chamber in the push-in wire connector until the wire forms electrical engagement with a resilient conductor that automatically flexes to form pressure engagement with the electrical wire. Typically, in the push-in wire connector the cylindrical elements of a cylindrical wire engage both a bus strip and a resilient conductor as they sandwich the electrical wire between a straight edge on the resilient wire conductor and the bus strip. However, the lack of an ability to increase the force on the contact regions between the edge, the bus strip and the wire limit the ability to enhance the electrical connection in a push-in wire through use of additional force.

Because of the limited contact area and the inability to increase the forces on the wire ends the push-in type of wire connectors are generally best used in regions where waterproof wire connections are generally not required.

If a waterproof connection is required in a push-in wire connector the conventional methods of waterproofing are to either place an annular elastic bushing around the wire before the wire is inserted into the push-in wire connector to form a waterproof seal around the electrical wire and the connector housing. Another method is to inject a sealant in the push-in wire connector after the wire has been inserted into engagement with the electrical conductor and bus strip therein. In still another method of waterproofing push-in wire connectors the entire push-in wire connectors with the electrical wires therein is inserted into a housing containing a sealant which allows one to encapsulate the entire push-in wire connector and thereby waterproof the wire connections therein. Each of the methods involve some type of preparation or handling of the push-in wire connector in order to protect the electrical connection from moisture and corrosion.

### SUMMARY OF THE INVENTION

A waterproof wire connector comprising a push in wire connector having a wire chamber therein for receiving and forming electrical engagement with an electrical wire axially inserted therein with the wire connector having a wire port with a self healing member extending across the entry to the wire port to prevent moisture from entering the wire connector whereby pushing the wire into the wire connector forces the end of an electrical wire to pierce the self healing member. One continues to push on the electrical wire until the end of the electrical wire is in electrical engagement with an electrical conductor in the wire connector. The coaction between the self healing member extending across the entry to wire port and the wire covering extending thereto has been found that through use of self healing material one can form and maintain an annular seal which is sufficiently waterproof to prevent moisture from coming into contact with the wire connection in the push-in wire connector. Consequently, using a layer of self healing material one can form a waterproof push-in wire connector without the need for a sealant in the wire connector and without losing the benefit of the one step method of forming an electrical connection through one continuous motion of inserting a wire into the push-in wire connector.

### BRIEF DESCRIPTION OF THE DRAWINGS

FIG. 1 is an exploded view of a self healing push-in waterproof wire connector;

FIG. 2 is an assembled view of the self healing push-in waterproof wire connector of FIG. 1;

FIG. 2A is a partial side view of a self healing push-in waterproof wire connector;

FIG. 2B is a partial sectional front view of a self healing push-in waterproof wire connector forming a junction;

FIG. 3 is a side view of a self healing entry member;

FIG. 4 is a perspective view of the self healing entry member of FIG. 3

FIG. 5 is a perspective view of a planar self healing entry member;

FIG. 6 is a cross sectional view revealing resilient wire engaging member in the push-in wire connector of FIG. 1;

FIG. 7 is an exploded view of another example of self healing push-in waterproof wire connector;

FIG. 8 is a top view of entry member of the of self healing push-in waterproof wire connector of FIG. 7;

FIG. 9 is a sectional view taken along lines 9-9 of FIG. 7;

FIG. 10 is a perspective view of a of self healing push-in waterproof wire connector with a test port; and

FIG. 11 is a perspective view of self healing push-in waterproof wire connector with a test port.

### DESCRIPTION OF THE PREFERRED EMBODIMENT

FIG. 1 shows an exploded view of a self healing push-in waterproof wire connector 10 comprising a rectangular shaped electrically insulated housing 11 having a pocket 11a for receiving a push-in wire connector 12. Push-in wire connector 12 includes an end face 12b having a set of four cylindrical wire ports 12a that provides access passages to internal wire engaging members located within the interior of wire connector 12. A feature of the push-in wire connectors is that in one motion a wire can be electrically connected to an electrical connector or bus strip merely by axially inserting a wire into a wire port until the wire engages a resilient member located within the wire connector.

In order to avoid water corrosion of the electrical connection within a wire connector it is important that the interior of the wire connector be kept free from moisture. One of the ways of protecting an electrical connection from moisture is shown in U.S. Pat. No. 7,972,166, which contains a sealant within the wire connector that forms a waterproof covering around the electrical wire connection located therein. Another method is to place a grommet or elastic bushing around the wire and seal around the wire through establishment of an interference fit between an elastic bushing or grommet and the exterior surface of the wire as the interference fit can keep moisture from penetrating past the bushing or grommet.

In contrast to the use of a sealant within the push-in wire connector or to establishment of an interference fit between a bushing and a wire it has been found that a self healing material that extends over a wire port entrance to the push-in wire connector can protect the interior of the wire connector from moisture both before one secures a wire therein or after one secures a wire therein. In the invention described herein no sealant is required either inside or outside of the push-in wire connector nor does one need to establish an interference fit between the wire and an elastic bushing or grommet to waterproof the push-in wire connector.

In addition to the self healing member benefit of forming an unassisted waterproof seal around an electrical wire the use of a self healing material has also been found not to interfere with the engagement or reengagement of an electrical wire from a push-in wire connectors as it permits one to remove and reinsert an electrical wire thorough. Typically, self healing materials are a class of materials, such as polymers, that when subjected to structural damage can repair themselves. In the present invention the self healing members is used as a moisture barrier around an electrical wire to prevent moisture from entering into the wire connector thus eliminating the need for other water protection methods.

In the invention described herein the electrical connection, which is formed within push-in wire connector 10, is protected from moisture through a self healing waterproof member 13 that extends across an open wire port of a push-in wire connector. It has been found that the or self healing material has sufficient memory so that if the material is axially pierced or punctured by a wire, even though the piercing action creates a hole therein, the self healing material can subsequently conform to the outside of the wire with sufficient internal pressure so as to form a watertight seal around the exterior surface of electrical wire. Thus, a feature of the invention is that a self healing cover, which is placed over a wire inlet port, has sufficient strength to protect the electrical contacts within the push-in wire connector from moisture before the push-in wire connector is ever used as well after a wire has been inserted into the push-in wire connector and that the protection can be obtained without interfering with the conventional one step operation of the push-in wire connector.

In the example shown in FIG. 1 the push-in wire connector 10 includes a set of four wire port covers 13a that are integral to a one-piece self healing member 13 with each of the wire port covers 13a extending partially into the wire ports 12a.

Examples of push-in wire connectors, which are known in the art include U.S. Pat. Nos. 7,833,038; 7,972,166 and 8,052,462 which are hereby incorporated by reference.

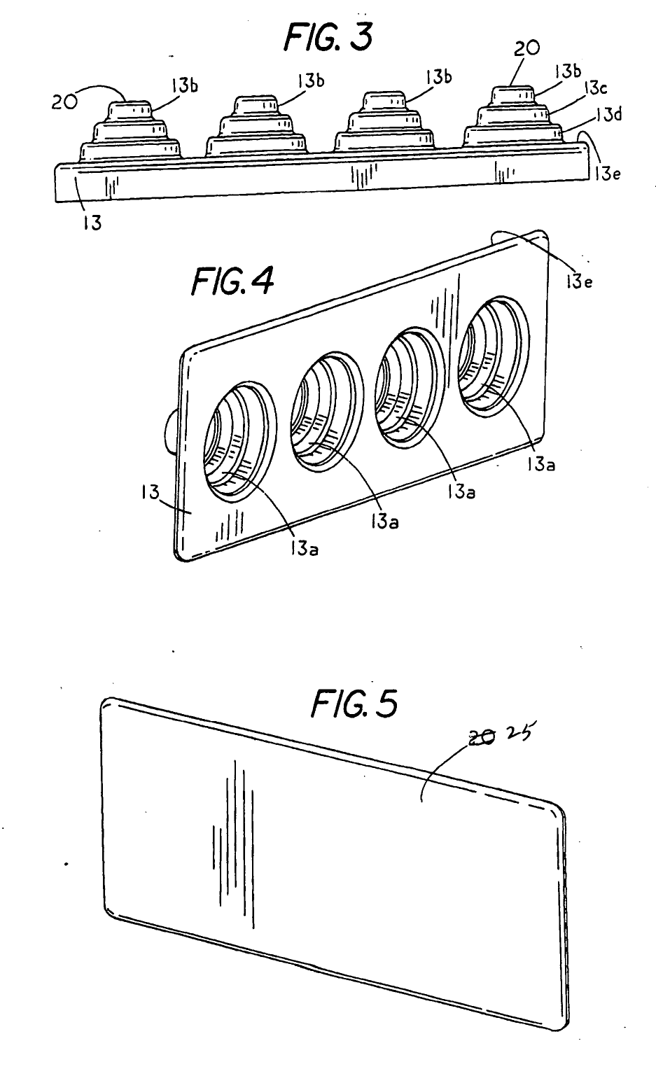

FIG. 3 shows a side view of self healing member 13 and FIG. 4 shows an isolated perspective view of the one-piece rectangular self healing member 13 having a set of four integral wire port covers 13a for extending across and into the wire ports 12a. When assembled, the planar face 13e of sealing member 13 forms face-to-face sealing engagement with the planar end face 12b of connector 12 to prevent moisture from entering into wire connector 12 either in the absence of a wire in the wire connector 12 or in the presence of a wire extending through the self healing member 13. The self healing member 13 includes a set of four conical shaped inlet pyramids 13a (FIG. 3) that have been formed in sealing member 13 by molding or forming a set of concentric cylindrical sections 13b, 13c, and 13d into sealing member 13. The set of pyramids 13a each terminate in a circular end member 20 that can be pierced by an electrical wire. In the example shown, self healing push-in waterproof wire-connector 10 also includes an external end member 14, which is positionable on one side of sealing member 13, with the external end member containing a set of wire ports 14a that are in axial alignment with the pyramids 13a and the wire connector ports or wire sockets 12a. The external end member 14 may be secured to connector 12 to sandwichingly hold the sealing member 13 in a sealed condition against the end face 12b of push in wire connector 12 to prevent moisture from entering the push-in wire connector 12.

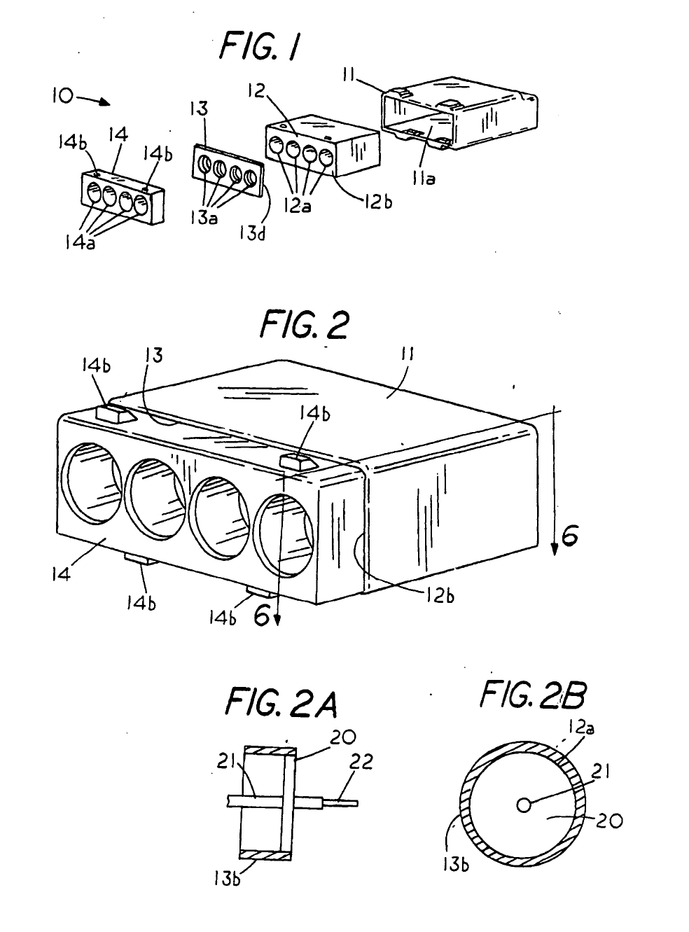

FIG. 2 shows a partially assembled view of the self healing push-in waterproof wire connector of FIG. 1 with the end member 14 abutted against one face of self healing member 13 and the end face 12b of wire connector 12 abutted against the other side of self healing member 13 as the end member tabs 14b are about to be engaged to recesses (not shown) located on the inside of housing 11. That is the tabs 14b engage a lip (not shown) in the housing 11 so that the push-in wire connector, the sealing member 13 and the member 14 can be mechanically held together within housing 11. The sandwiched relationship of self healing member 13 between the end member 14 and the end face 12b forms a waterproof junction therebetwen to prevent radial moisture seepage into a wire chamber in push in wire connector 12. Thus, in the example shown that prior to use the wire chamber in push in wire connector 12 is maintained in a sealed or waterproof condition through a self healing member 13 that seals the wire ports 12a to the wire connector 12 thereby providing a waterproof wire chamber behind the self healing member 13.

FIG. 2A shows a partial side view of an end sealing member 20 located on a pyramid 13a. In the example shown an electrical wire 21 extends through the end self healing member 20. In this example the self healing member 13 comprises a self healing material such as silicone rubber that has been punctured by insertion of the wire end 22 through the end face 20.

FIG. 2B shows a partial sectional front view revealing the end sealing member 20 with forming a circumferential water proof junction between the external cylindrical surface of the wire 21 and itself. That is, the member 20, which is in one piece member is sufficiently fragile so that it can be punctured by wire end 21 and once punctured the inherent resilient characteristics of the sealing member 20 causes the sealing member to radially contract around the wire 21 with sufficient internal force to form a water proof connection around the wire 21, which prevents moisture from entering into the wire ports 12a that could cause corrosion on the electrical connection between the wire end 22 and the push-in wire connector therein.

An example of an available self healing material is compliant silicone rubber which is commercially available in sheet or molded form and is weather resistant and has electrical insulating properties. The seal healing member allows a puncture therein to self heal to form a junction that is sufficiently tight that the self healing material forms a waterproof junction with the wire covering.

FIG. 3 shows an isolated top view of self healing member 13 revealing a molded set of four cylindrically stepped collars 13b, 13c and 13d which extend from the face 13e of self healing member 13.

FIG. 4 shows a perspective view of the self healing member 13 with the four steeped wire collars 13a extending outward from self healing member 13.

While the self healing member 13 comprises a set stepped port covers the example of FIG. 5 shows a perspective view of another example of a self healing member that can be used to waterproof a push in wire connector. In this example a rectangular planar sheet of silicone rubber 25, is used in place of the conical stepped self healing member 13, which is shown in FIG. 2. The self healing member 25 would be sandwiched between end member 14 and wire connector 12 so that the self healing member 14 covers the wire inlet ports 12a in wire connector 12. It has been found that the silicone material in sheet can recover from piercing an object therethrough sufficiently so as to form a waterproof seal around the wire after the wire is extended through the member 14. In operation the thickness of the self healing member or membrane should be sufficiently thick so that the membrane retains its structural integrity to seal around the wire in the presence of the environment outside the wire connector. In most applications a membrane having a thickness of 0.020 inches is sufficient to both seal and protect the environment although lesser thickness may used depending on the size and wires connected in the push-in wire connector. In addition, the maximum thickness of the membrane, while not limited by structural integrity may be limited by the gauge of the wire as well as type of wire. For example, a stiffer heavier gauge wire can pierce a thicker membrane without the wire bending while a smaller gauge wire may bend as one attempts to force the wire through the self healing member. Therefore, the thickness of the membrane should have a minimum thickness that maintains the seal around the wire once the wire is inserted into the push-in wire connector and should have a maximum thickness determined not by sealing conditions but by the relationship of inherent resistance of the self healing member to the axial rigidity of the wire since the wire needs to without bending be axially inserted through the self healing member into contact with the electrical connector within the push-in wire connector.

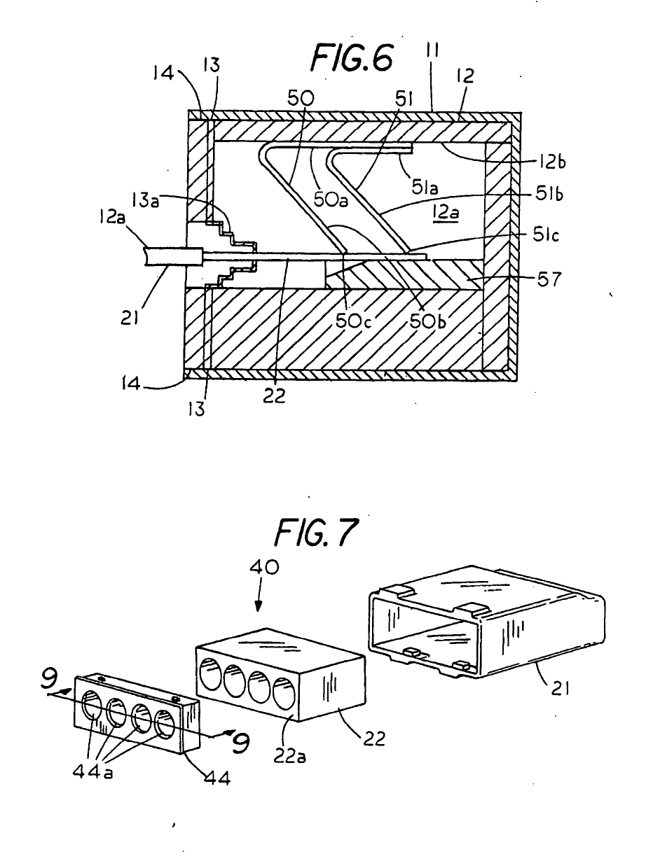

FIG. 6 shows a sectional view taken along lines 6-6 of FIG. 2 revealing an example of a set of internal resilient wire engaging members 50 and 51, which may be located in push-in wire connector 12. The wire engaging members 50 and 51 comprise a first Vee shaped resilient member 50 and a second Vee shaped resilient member 51 each having a top leg and a bottom leg. A resilient member top leg 50a is held against face 12b by means not shown and a resilient member top leg 51a is held against top leg 50a also by means not shown. A first lower leg 50b of wire engaging member 50 extends at an acute angle downward toward a bus block 57 and similarly, a second lower leg 51b of wire engaging member 51 extends at an acute angle downward toward bus block 57. The resilient member 51 includes an edge 51c that forms a topside electrical connection with the bared wire end 22 of the electrical wire 21 when an electrical wire 22 is axially inserted into wire port 12a and similarly, the resilient member 50 includes an end 50c that forms a topside electrical connection with the bared end 22 of the electrical wire 21 when the electrical wire 22 is axially inserted into wire port 12a to thereby hold wire end 22 in electrical contact with bus strip 57. In this example, the electrical connections formed between resilient member 50 and wire 21 as well as the electrical connection formed between resilient member 51 and wire 21 can be maintained in a waterproof connection through the self healing between a pyramid 13a of self healing member 13 and the wire end 21 that has been extending there through by axial insertion of the wire end into push-in wire connector 12. In other examples the wire covering 21 may be inserted through the self healing member to form a waterproof seal between the wire covering 21 and the resilient sealing member 13. In still other examples only a since resilient member may be used.

FIG. 7 shows an exploded view of another example of a self healing push in waterproof wire connector 40 with the push-sin wire connector including an electrically insulated housing 21, a push in wire connector 22 and a self healing end insert 44 having a set of wire port covers 44a therein. In this example the end insert 24 is formed from a block of self healing material with a set of four cylindrical wire ports 24a that extend partially through the block.

FIG. 8 shows a top view of the block of self healing material forming an end insert 44 with tabs 24d for engagement with a housing. The end insert 44 is shown in perspective view in FIG. 7 revealing tabs 24d for forming engagement with a lip on the interior of housing 21 to mechanically hold the block of seal healing material in housing 21.

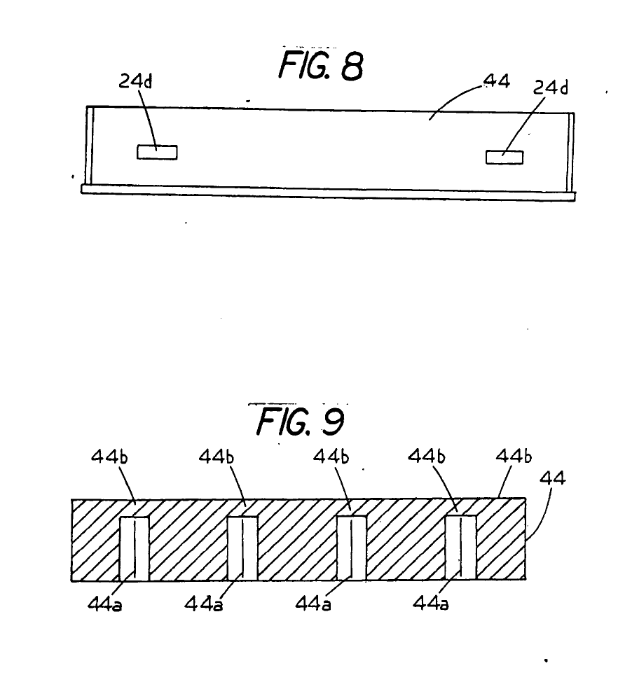

FIG. 9 is a cross sectional view taken along lines 9-9 of FIG. 7 revealing the elongated cylindrical wire ports 44a with a wire port cover 44b forming a wire penetration region for inserting an electrical wire therethrough. In this example a block of self healing material 44 is used to form the end member 44 with the wire port covers with a portion of the self healing member having a thinner region 44b, which is wire penetrable. In this example, the end member 44 which is formed from a block of self healing material eliminates the need for a separate end member as shown in FIG. 1.

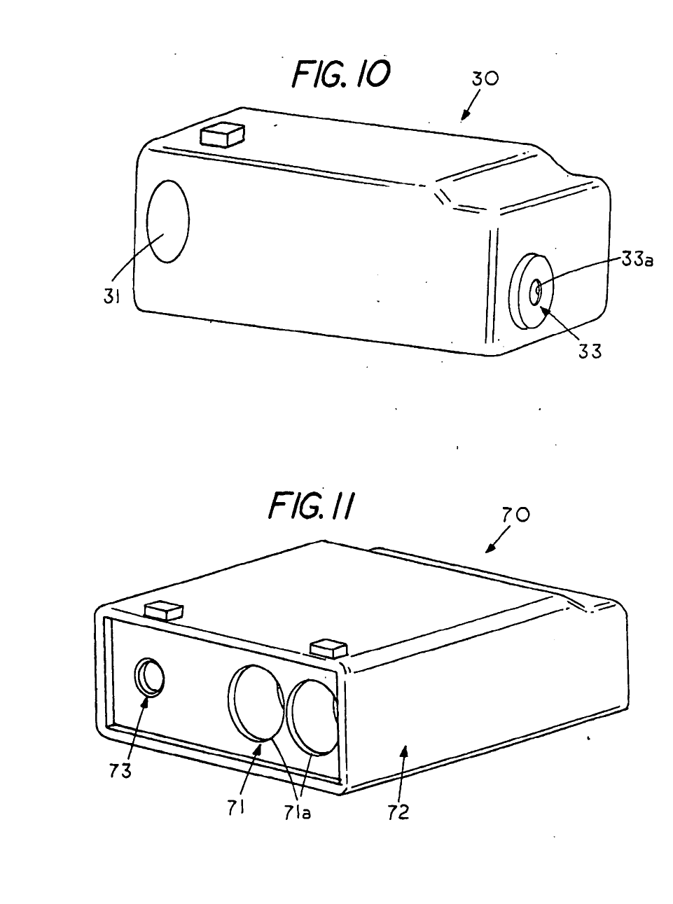

FIG. 10 is a perspective view of a self healing push in electrical wire connector having an internal wire engaging member (not shown). One end of waterproof wire connector 30 includes a self healing wire port cover 31 to maintain the wire engaging member 32 in a waterproof condition and the other end includes a wire port cover 33 having a center area 33a for inserting a test probe therein. In this example an electrical connecting can be formed in the push-in wire connector by inserting an electrical though the resilient member forming the wire port 31. Once inserted one can test the electrical connection therein through the test port 33, which allows one to check the electrical connection in the self healing push in wire connector 30 without having to disturb the wires extending through the wire port 31. Thus, the use of the self healing member allows one to have a separate test port to enable one to check on the electrical connection therein without disturbing the connection or the seal around wire extending through wire port cover 31. Once tested one can remove the test probe from test port cover 33a and the self healing member 33 closes on itself to maintain the wire connector therein in a waterproof condition.

FIG. 11 is a perspective view of another example of a self healing push in waterproof wire connector 70 having an electrical insulated housing 72 with an end insert 71 formed from a block of self healing material. 71 Two electrical wire ports 71a are located on one side of the end insert 71 and an electrical test port 73 is located on the opposite side. In this example the internal wire connector members, which are similarly to resilient member 50 or 51 of FIG. 6, are protected from moisture by the self healing member 71, which forms a waterproof seal around wires that are extended into the wire connector through the self healing member 71. The test port 73 allows one to test for electrical connective without having to insert a probe into the wire ports which may cause disruption of the seal formed around the wire surfaces therein.

With only one opening formed in the self healing member one can improve the ability of the material to form a waterproof seal since the inherent self healing forces of the self healing member can be exerted radially inward all external surfaces of the wire to thereby provide a water proof junction between the wire and the self healing member. In general the thickness of the self healing member should be sufficient to form a cylindrical axial seal along an exterior surface of an electrical wire when the wire is axially forced through the self healing member.

While the invention has been described in regard to the well known push-in wire connector it is envisioned that other types of electrical wire connectors may benefit from the invention described herein.

I claim:

1. A waterproof wire connector comprising:
a housing having a wire chamber therein for receiving an electrical wire, said housing having an end with a wire port for insertion of an electrical wire therein;
a wire connector located in the wire chamber;
a self healing member extending across said wire port whereby the coaction of the wire port and housing prevent moisture from entering into the wire chamber in the housing in the absence of a wire in the wire chamber or the presence of a wire extending through the self healing member.

2. The waterproof wire connector of claim 1 including an entry member wherein the self healing member is sandwiched between said entry member and the end of the housing.

3. The waterproof wire connector of claim 1 wherein the self healing member is adhesively secured to the end of said housing.

4. The waterproof wire connector of claim 1 wherein the housing includes at least two wire ports with each of the wire ports containing a wire connector therein.

5. The waterproof wire connector of claim 4 wherein the housing includes a test port with the test port having a self healing member extending over the test port.

6. The waterproof wire connector of claim 5 wherein the test port is located on an end opposite the end of the housing having the wire port.

7. The waterproof wire connector of claim 1 wherein the self healing member includes a conical collar.

8. The waterproof wire connector of claim 7 wherein the conical collar is a stepped conical collar.

9. The waterproof wire connector of claim 5 wherein the housing has an open end for insertion of the wire connector therein.

10. The method of waterproofing a push in wire connector comprising:
forming an electrical insulating and water proof housing;
placing an electrical push-in wire connector having a wire port in the housing;
placing a self healing material over the wire port to inhibit or prevent moisture from entering into the housing; and
in one step forming an electrical connection and waterproofing an electrical connection therein by extending a wire through the self healing material and into electrical contact with an electrical connector therein.

11. The method of claim 10 wherein the step of placing a self healing material over the wire port where minimum thickness of the self healing material is limited by the structural integrity of the membrane and the maximum thickness is limited by the axial rigidity of the wire that is extended through the self healing material.

12. The method of claim 10 including the step of forming a series of cylindrical steps in the self healing member.

13. The method of claim 10 including the step of forming a test port in the housing with the test port spaced from the wire port and the test port having a self healing member therein.

14. The method of claim 10 wherein the electrical wire connector is a push-in wire connector.

15. The method of claim 10 including the step of axially extending an end of an electrical wire through the self healing material and into engagement with the electrical wire connector therein.

16. The method of claim 10 wherein the self healing member has a thickness sufficient to form a cylindrical axial seal along an exterior surface of an electrical wire.

17. The method of claim 10 including the step of forming a test port on an opposite side from the wire port.

18. The method of claim 17 including placing a second self healing member in the housing with the second self healing member proximate the test port.

19. The method of claim 10 wherein the step of placing a self healing member comprises placing a planar sheet of silicone rubber over the wire port.

20. A waterproof push-in wire connector comprising:
a housing having a wire receiving chamber, said housing having a wire port for axial insertion of an electrical wire therein;
a resilient wire engaging member located in the wire chamber for forming electrical engagement with a wire axially inserted into the wire port;
a self healing member extending across said wire port to thereby block entry of moisture to the wire port, said self healing member characterized by preventing moisture from entering the wire port when the push-in wire connector is in an unused condition or used condition caused by a piercing of the self healing member through axial insertion of a wire through the self healing member with the moisture prevention obtained solely through the self healing member in engagement with the wire.
